(19) United States
(12) Patent Application Publication
(10) Pub. No.: US 2015/0241984 A1
(43) Pub. Date: Aug. 27, 2015

(54) Methods and Devices for Natural Human Interfaces and for Man Machine and Machine to Machine Activities

(71) Applicant: Yair ITZHAIK, Nahariya (IL)

(72) Inventor: Yair ITZHAIK, Nahariya (IL)

(21) Appl. No.: 14/629,662

(22) Filed: Feb. 24, 2015

Related U.S. Application Data
(60) Provisional application No. 61/943,648, filed on Feb. 24, 2014.

(51) Int. Cl. G06F 3/01; G06F 3/041

(52) U.S. Cl. CPC G06F 3/017; G06F 3/0416

(57) ABSTRACT

The present invention provides a method for activation of functions in a target computer device using a smart mobile device The method comprising the steps of: receiving inputs from the smart mobile device sensors to identify motion or orientation of the device in space and identify touch screen inputs, receive inputs from camera of the target computer device capturing movement and orientation of smart mobile device and/or motion of user's body parts, applying algorithms to translate and synchronize data from various sensors of the smart mobile device, by applying cross-match algorithm on data from different multiple sensors, process simultaneous inputs data from the smart mobile device and/or the data from camera of the target device which identifies the movements of the smart device to determine user 3D control commands based on pre-defined rules and translating determined control commands into instructions in the target computer device.

### TECHNICAL FIELD

The present invention generally relates to the field of computerized devices' interface, systems, devices and methods that are used to control and interact with other devices, and more particularly to human-activated input devices and wearable devices.

### SUMMARY OF INVENTION

The present invention provides a method of activation functions of application in a target computer device including 3d movements functions, using a smart mobile device The method comprising the steps of: receive inputs from the smart mobile device sensors including at least one of: motion sensor: tilting/accelerator sensor to identify motion or orientation of the device in space and identify touch screen inputs that follow the fingers movement on the touch screen or the hovering of the fingers over and/or keystrokes, receive inputs from camera and/or microphone of the target computer device capturing movement and orientation of smart mobile device as moved by the user's hands and or motion of user's body parts, applying script language and algorithms enabling to translate and synchronize data from various sensors of the smart mobile device, by applying cross-match algorithm on data from different multiple sensors to map and describe user's real world physical motion and orientation parameters such as his 3d position and movements, process simultaneous inputs data from the smart mobile device including data of motion of fingers along the touch screen or/and identified motion, a linear movement and/or a rotation movement of the smart mobile device by the user's hands, /and/or the data from camera of the target device which identifies the movements of the smart device to determine user 3D control commands based on pre-defined rules. using parameters which relates to at least one of: motion of fingers along the touch screen movement in space, tiling movements of body's parts or hands grabbing and/or moving the smart phone device in space and translating determined control commands into instructions of designated application of the target computer device or the mobile device.

According to some embodiments of the present invention the method further comprising the step of: translating control commands into objects or coordinate system movements on the screen of target computerized device.

According to some embodiments of the present invention the method further comprising the step of sending in real-time feedback to the smart device to activate processes thereof or to the sensors to change sensors configuration based on analyzed sensor data.

According to some embodiments of the present invention the commands include building 3D objects models by user based on equivalent 3D objects presented to the user on the target screen.

According to some embodiments of the present invention the commands include operating 3D game on the target computerized device.

According to some embodiments of the present invention a given 3D pixel objects models of user's organs are used to identify finger touch in pre-defined locations on the user organ or any object enabling to simulate reduced keyboard for using with smart mobile device, where each predefined location on the organ or object simulate at least one key or function in the smart mobile device.

According to some embodiments of the present invention further comprising the step of identifying user finger movement along predefined path along the screen, is translated into predefined graphical command including movement of an object in a third dimension or zooming in or out.

According to some embodiments of the present invention further including the step of: identifying the movement of a first finger of user's hand along horizontal and vertical axis along the smart device touch screen and a second hand's finger along a predefined path can activate linear movements on the targeted screen in all three (x, y, z) axis in the same time.

According to some embodiments of the present invention, each movement of the finger on the screen is translated into different proportion of movement on the target screen based on pre-defined factor.

According to some embodiments of the present invention, the predefined path is along the edge of the smart device touch screen.

According to some embodiments of the present invention the process simultaneous inputs data include integrating data information of 3D movement of the smart phone with finger movement of the smart phone screen for determining specific control commands.

The present invention provides a method of activation functions of application in a target computer device including 2d and/or 3d movements functions, using a smart mobile device associated attached with interface device simulating electronic mouse interface capabilities. The method comprising the steps of: receive inputs from the smart mobile device sensors including at least one of: motion sensor: tilting/accelerator sensor to identify motion and orientation of the device in space and identify touch screen inputs and/or keystrokes, receive inputs from the interface device, applying script language and algorithms enabling to translate and synchronize data from various sensors of the smart mobile device and input data of the interface device, by applying cross-match algorithm on data from different multiple sensors to map and describe user's real world physical motion and orientation parameters such as his 3d position and movements, process simultaneous or one after another, inputs data from of the smart mobile device and the interface device to determine user 2D or 3D control commands based on motion of fingers along the touch screen movement in space or tiling movements of body's parts or hands grabbing and moving the device in 2D or 3D in space and translating determined control commands into instructions of designated application of the target computer device.

According to some embodiments of the present invention the smart mobile device includes reduced keyboard layout which consists of number of adjacent areas, one of them represents a ‘blank’ key and each one of the others areas contains and presents one or more letters or/and symbols, that can be keystroked by various keystroke types.

According to some embodiments of the present invention is provided a method of activation functions of application in a target computer device including 3d movements functions, using a smart mobile device associated with interface device simulating electronic mouse interface capabilities. The method comprising the steps of: receive inputs from the smart mobile device sensors including at least one of: motion sensor: tilting/accelerator sensor to identify motion and orientation of the device in space and identify touch screen inputs and/or keystrokes; receive inputs from the interface device, receive inputs from camera and/or microphone of the target computer device capturing movement and orientation of smart phone/pad device and or user body parts, applying script language and algorithms enabling to translate and synchronize data from various sensors of the smart mobile device and input data of the interface device, by applying cross-match algorithm on data from different multiple sensors to map and describe user's real world physical motion and orientation parameters such as his 3d position and movements, process simultaneous inputs data from of the smart mobile device, the interface device and camera of the target device to determine user 3D control commands based on motion of fingers along the touch screen movement in space or tiling movements of body's parts or hands grabbing and moving the device in space and translating determined control commands into instructions of designated application of the target computer device.

### BRIEF DESCRIPTION OF THE DRAWINGS

The present invention will be more readily understood from the detailed description of embodiments thereof made in conjunction with the accompanying drawings of which

FIG. 1 is a block diagram illustrating a system computer control interface, according to some embodiments of the invention;

FIG. 2 is a flow chart illustrating activity control application, according to some embodiments of the invention;

FIG. 3 a flow chart illustrating activity control application, according to some embodiments of the invention;

FIG. 4 a flow chart illustrating activity control application, according to some embodiments of the invention;

FIG. 5 is a flow chart illustrating activity control application, according to some embodiments of the invention;

FIG. 6 is a flow chart illustrating activity control application, according to some embodiments of the invention;

FIG. 7 is an example of calibration process of capturing KlikePad's position and movements using a camera according to some embodiments of the invention;

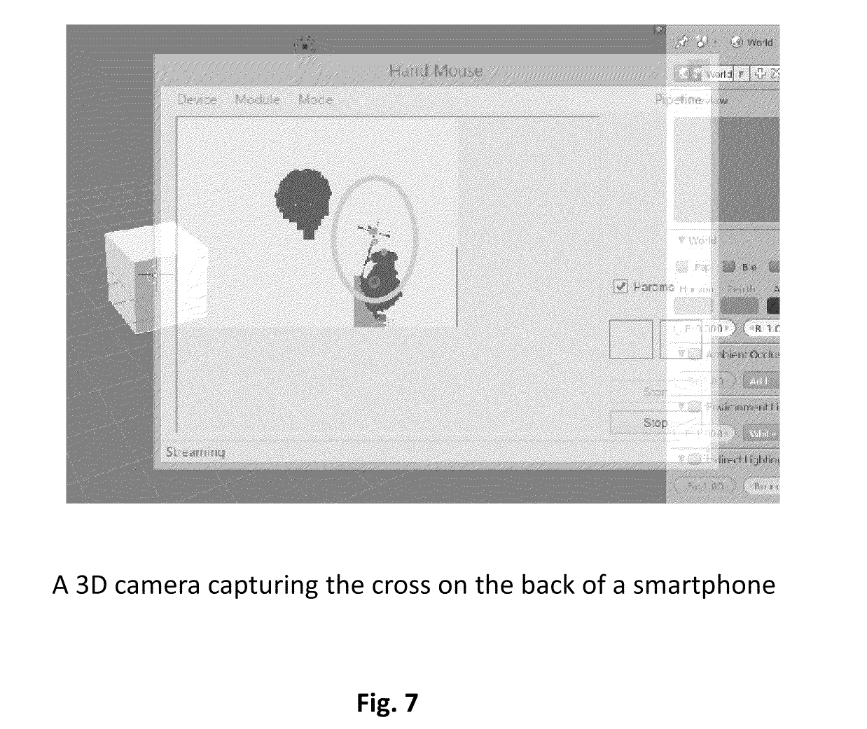

FIG. 8 is an example mobile device position and movements and orientation according to some embodiments of the invention;

FIG. 9 is an example 3D object creation according to some embodiments of the invention;

FIG. 10 is an example illustrating the camera position in reference to a physical object by drawing a line with known angle to the camera axis coordinate, such as the distant of any other object in the z axis can be measured by triangulation with its (x, y) projection.

FIG. 11 is an example of presenting grid with numbers, together with the transparent image of a gestures to calculate the exact position of the moving hand or fingers or head or other part of the body or the object in hand, according to some embodiments of the invention; and

FIG. 12 is an example of presenting reduced keyboard on the body of the user, according to some embodiments of the invention.

FIG. 13 is an example of an user interface simulating mouse capabilities, according to some embodiments of the invention.

FIG. 14 is an example reduced keyboard letter combination, according to some embodiments of the invention.

### DETAILED DESCRIPTION

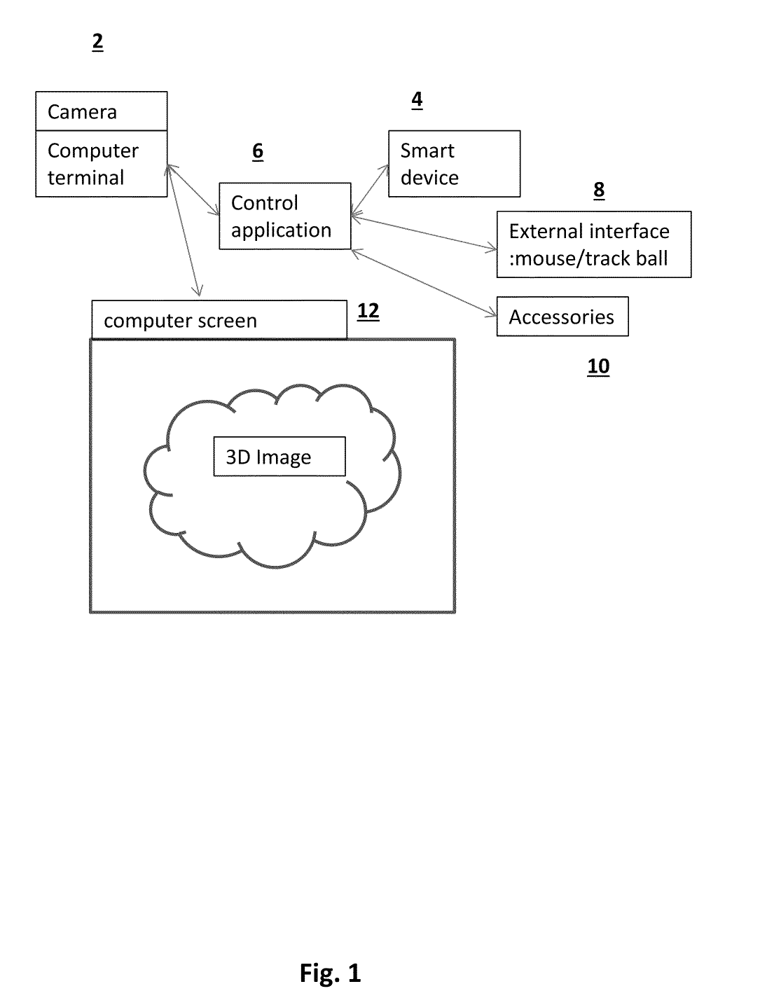

FIG. 1 is a block diagram illustrating a system computer control interface, according to some embodiments of the invention;

According to some embodiments of the invention, (‘KlikePad’) the smart device (4 in FIG. 1) is a computerized device such as but not limiting smartphone, that has touch screen and motion sensors such as accelerometer, or/and gyroscope, or/and compass and remote connections such as but not limiting Wi-Fi, Bluetooth, and USB, can be used as a remote control console to operate targeted device's (2 in FIG. 1) applications or operating-system using a control program (6 in FIG. 1) which can implemented as part of the target device or on the cloud or partly implemented on the smart device. The targeted device is a computerized device that has screen (12 in FIG. 1) and communication modules connections. The targeted device can have sensors such as but not limiting 2D or 3D camera or/and microphone that react to user's activities such as but not limiting moving any part of his body or moving the KlikePad in 2D or 3D space. And all the real-time data that is captured by the KlikePad sensors and its touch screen and the targeted device sensors is processed together by a ‘Sensor-Hub’ hardware or software that are embedded in the KlikePad or the targeted device. Clicking on icon on KlikePad′ touch screen can activate commands on both the KlikePad and the targeted device, and movement user's fingers on the touch screen can move the cursor in the targeted device screen. Sensors on both devices can be also but not limiting sensors that measure eyes movement, brain electronic activity, muscles movement and temperature measurement sensors.

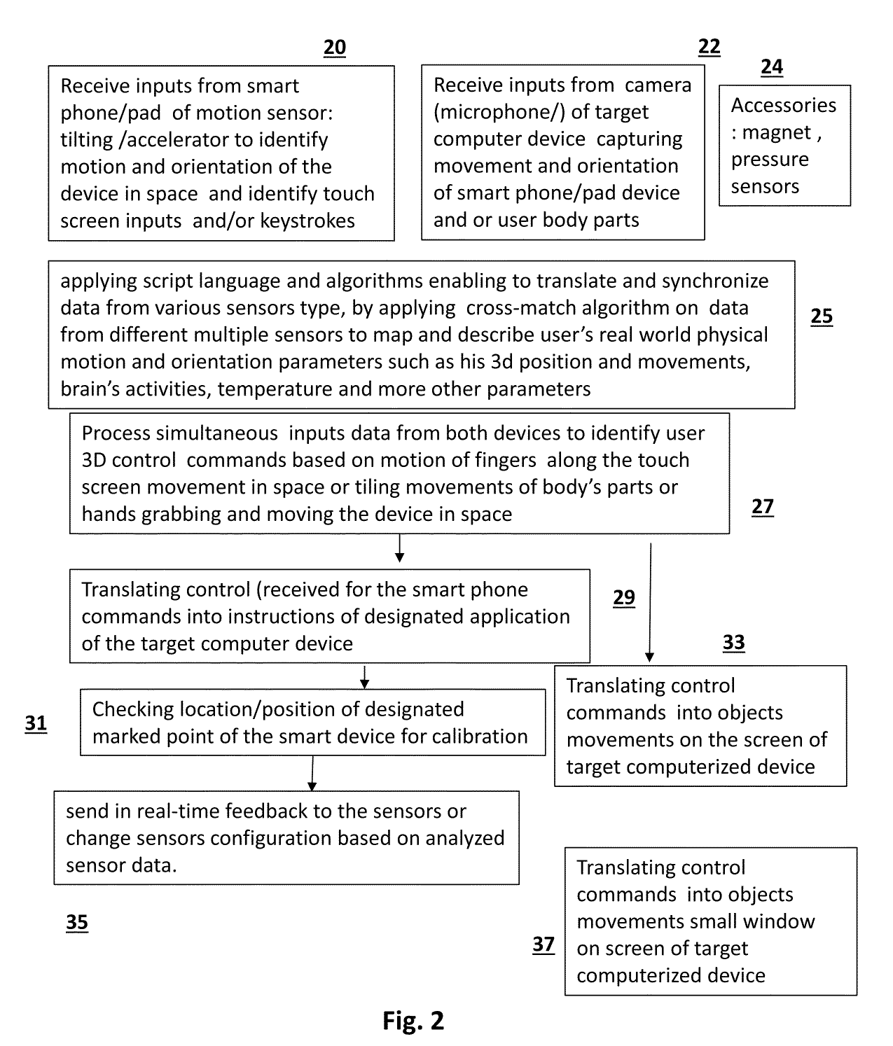

FIG. 2 is a flow chart illustrating activity control application, according to some embodiments of the invention; (20), (22) and (24) are all the sources of input data that is captured and processed in the same time:

(20) is all the input data that can come from the KlikePad: a) from smartphone/pad touch screen and from its motion sensors: tilting/accelerator to identify motion and orientation of the device in space when held and moved by user's hand in space and b) touch screen inputs and/or keystrokes.
(22) is the input from of target computer device such as camera (or microphone) capturing movement and orientation of smart phone/pad device held and moved by the user in space and or together with user body parts.
(24) data that come from other sensors such as brain's activities, temperature and other All this data that is captured from various sensors types is processed (25 and 27) in a synchronize way by applying script language and algorithms to translate it into commands, and by applying cross-match algorithm on data from different multiple sensors to map and describe user's real world physical motion and orientation such as his 3d position and movements in 6 degrees of freedom (linear movement and rotation).
(29, 31 and 33) the processed data is translated into commands and 3d movements to control the application of the target computer device, and this application (35) can send back its feedback or iterate with the KlikePad, activate processes and application at smart mobile device fine-tune sensors parameters, etc.
The target screen can show (37) the captured raw or processed data of KlikePad and the other sensors in parallel in a small screen.

The control application: Receive inputs from smart phone/pad of motion sensor: tilting/accelerator to identify motion and orientation of the device in space and identify touch screen inputs and/or keystrokes and receive inputs from camera (or microphone) of target computer device capturing movement and orientation of smart phone/pad device and or user body parts. Based on the received input the control program applies script language and algorithms enabling to translate and synchronize data from various sensors type, by applying cross-match algorithm on data from different multiple sensors to map and describe user's real world physical motion and orientation parameters such as his 3d position and movements, brain's activities, temperature and more other parameters.

The control program may further apply one of the following operations:process simultaneous inputs data from both devices to identify user 3D control commands based on motion of fingers along the touch screen movement in space or tiling movements of body's parts or hands grabbing and moving the device in space, translating control commands received for the smart phone commands into instructions of designated application of the target computer device, translating control commands into objects movements or 3d-coordinate system on the screen of target computerized device or translating control commands into movements both of the objects in a main screen and in an attached small window zooming local portion of the object on the screen of the target computerized device.

According to some embodiments the control program module may apply also to one of the following operations: Checking location/position of designated marked point of the smart device for calibration or send in real-time feedback to the sensors or change sensors configuration based on analyzed sensor data.

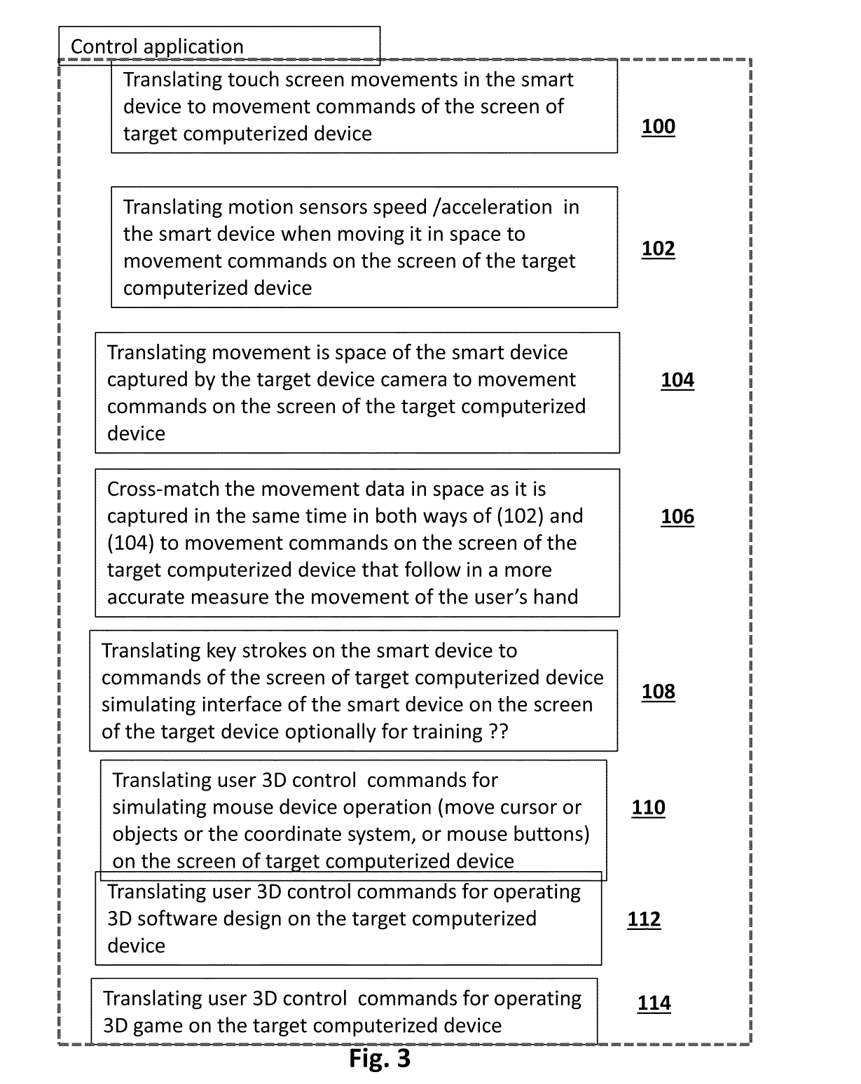

FIG. 3 is a flow chart illustrating activity control application, according to some embodiments of the invention. The control program may further apply the one of the following operations: (100) Receive inputs from the moving fingers on touch screen of the smartphone/pad and translate it into movements of objects in the target device's application,

(102) Receive inputs from motion sensors speed/acceleration in the smart device when holding it and moving it in space in 6 degrees of freedom (linear movement in (x, y, z) axis and rotation in (x, y, z) axis), to identify motion and orientation of the device in space and translate this into movement commands on the screen of the target computerized device,
(104) Receive inputs from camera of target computer device capturing movement and orientation of smart phone/pad device held and moved in space by user's hand in 6 degrees of freedom (linear movement in (x, y, z) axis and rotation in (x, y, z) axis), to identify motion and orientation of the device in space and translate this into movement commands on the screen of the target computerized device,
(106) Cross-match the movement data in space as it is captured in the same time in both ways of (102) and (104) to movement commands on the screen of the target computerized device that follow in a more accurate measure the movement of the user's hand, (108) Receive key strokes on the smart device and translate them into commands of the screen of target computerized device. (110) Translating user 3D control commands for simulating mouse device operation to move cursor or objects or the coordinate system or mouse buttons on the screen of target computerized device, (112) Translating user 3D control commands for operating 3D software design on the target computerized device, (114) Translating user 3D control commands for operating 3D game on the target computerized device.

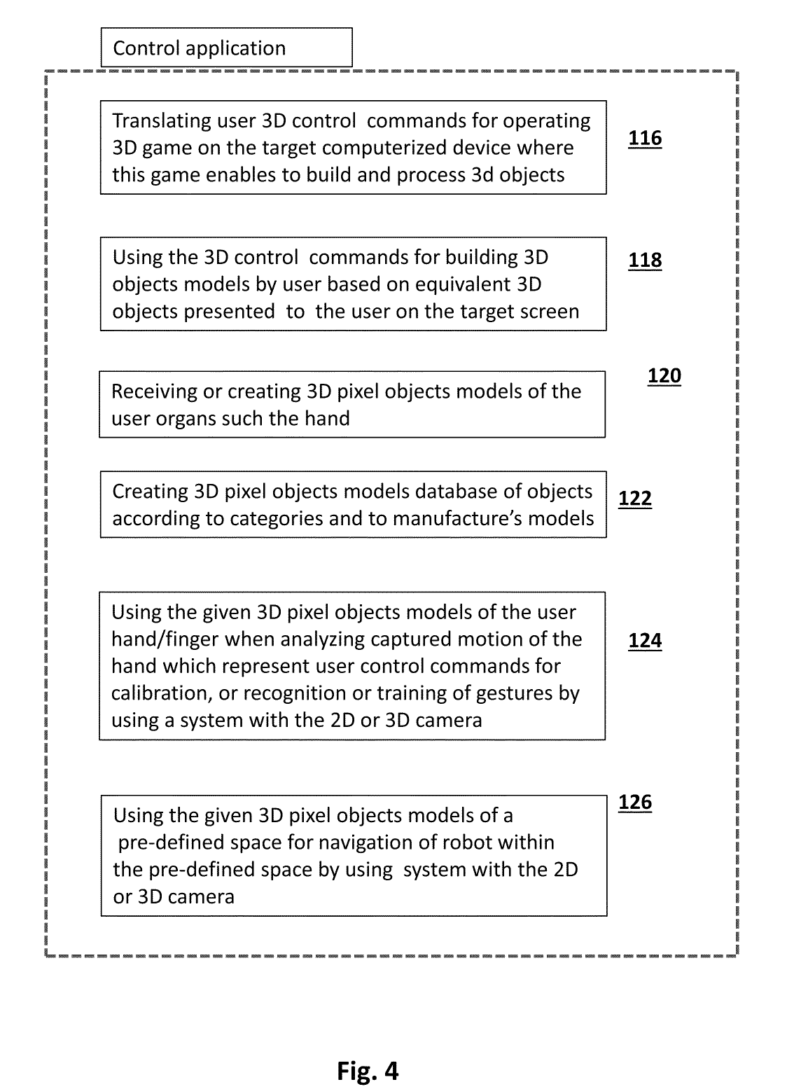

FIG. 4 is a flow chart illustrating activity control application, according to some embodiments of the invention, the control program may further apply the one of the following operations: (116) Translating user 3D control commands for operating 3D game on the target computerized device where this game enables to build and process 3d objects, (118) Using the 3D control commands for building 3D objects models by user based on equivalent 3D objects presented to the user on the target screen, (120) Receiving or creating 3D pixel objects models of the user organs such the hand, (122) Creating 3D pixel objects models database of objects according to categories and to manufacture's models, (124) Using the given 3D pixel objects models of the user hand/finger when analyzing captured motion of the hand which represent user control commands for calibration, or recognition or training of gestures by using a system with the 2D or 3D camera or (126) Using the given 3D pixel objects models of in a pre-defined space for navigation of robot within the pre-defined space by using a system with the 2D or 3D camera.

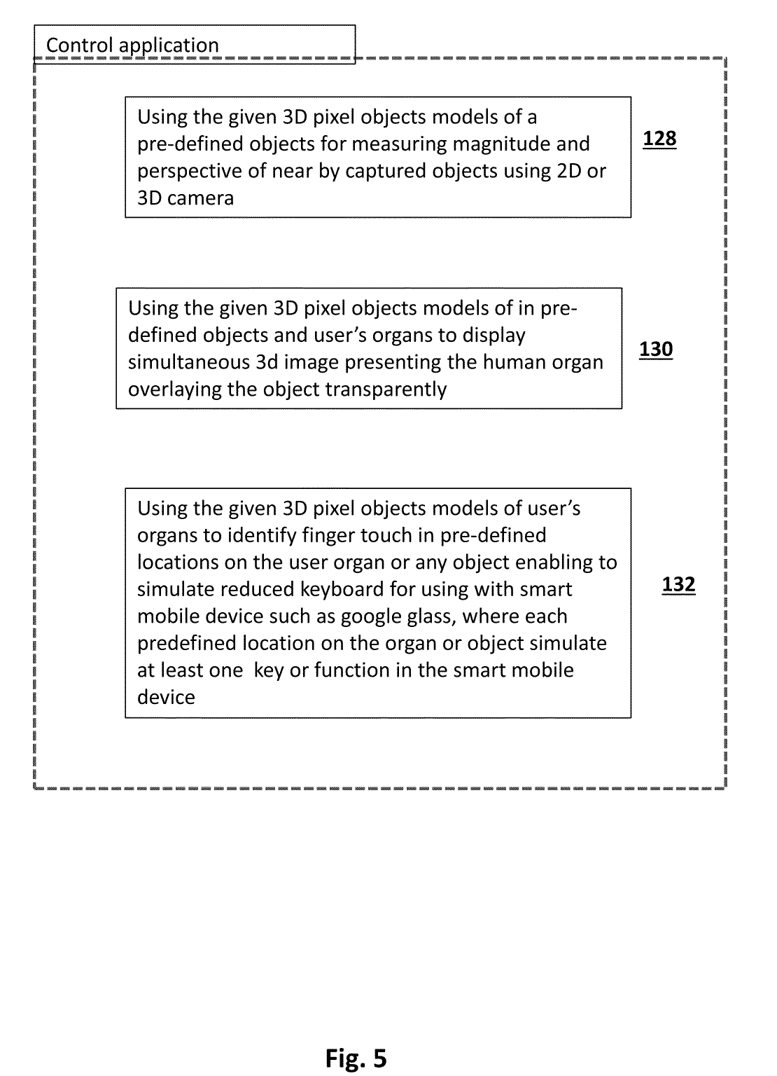

FIG. 5 is a flow chart illustrating activity control application, according to some embodiments of the invention. The control program may further apply the one of the following operation: (128) Using the given 3D pixel objects models a pre-defined objects for measuring magnitude and perspective of near-by captured objects using 2D or 3D camera, (130) Using the given 3D pixel objects models of a pre-defined objects and user's organs to display simultaneous 3d image presenting the human organ overlaying the object transparently, or (132) Using the given 3D pixel objects models of user's organs to identify finger touch in predefined locations on the user organ or any object enabling to simulate reduced keyboard for using with smart mobile device such as google glass, where each predefined location on the organ or object simulate at least one key or function in the smart mobile device.

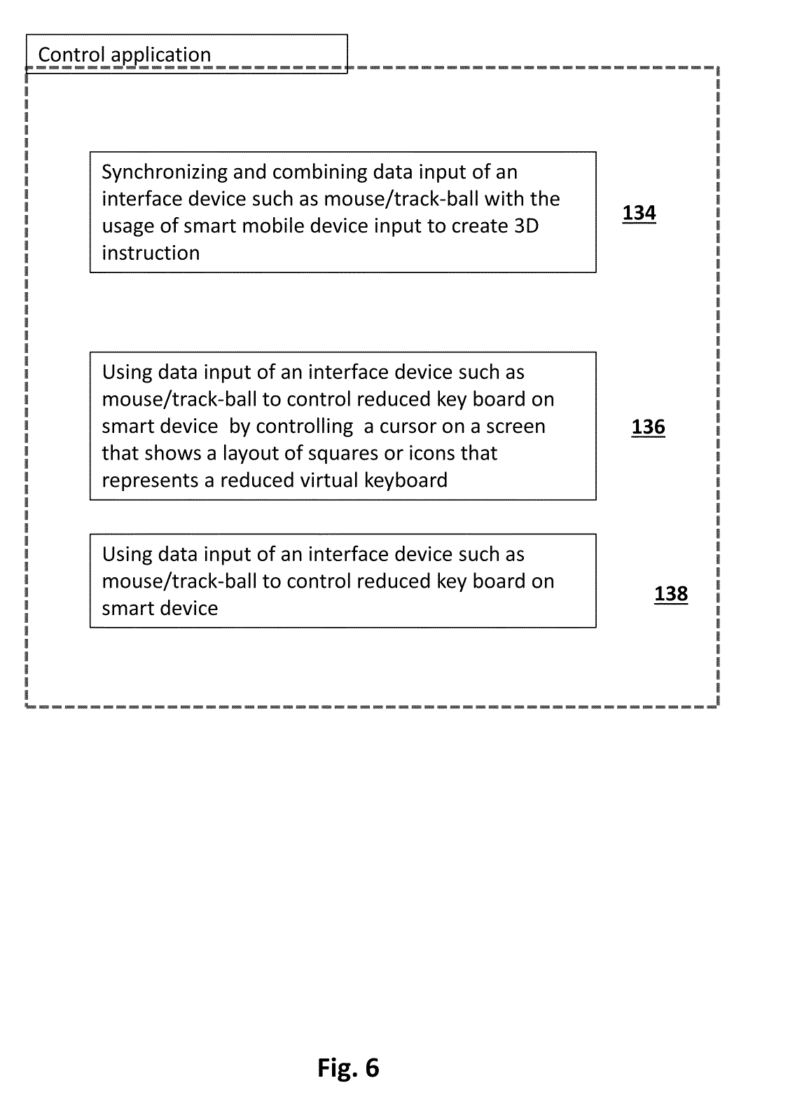

FIG. 6 is a flow chart illustrating activity control application, according to some embodiments of the invention. The control program may further apply the one of the following operations: (134) Synchronizing and combining data input of an interface device such as mouse/track-ball with the usage of smart mobile device input to create 3D instruction or (136) Using data input of an interface device such as mouse/track-ball to control reduced key board on smart device by controlling a cursor on a screen that shows a layout of squares or icons that represents a reduced virtual keyboard or (138) Using data input of an interface device such as mouse/track-ball to control reduced key board on smart device.

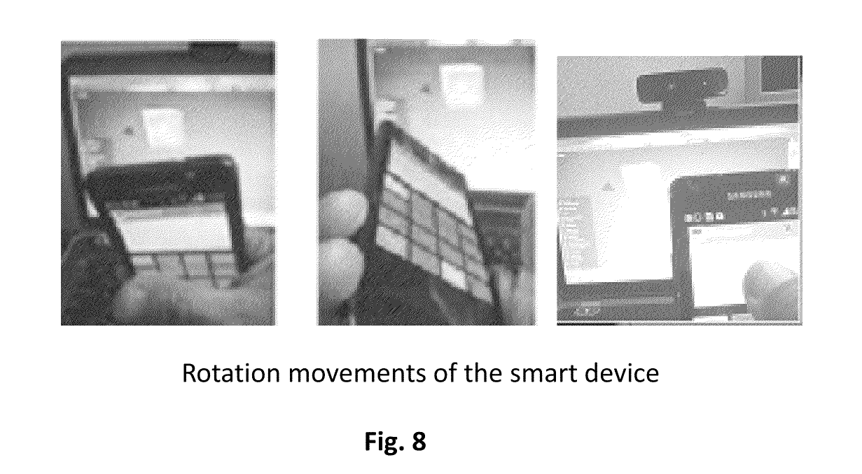

According to some embodiments of the invention, the KlikePad such as smartphone can have marking on its back and all sides for example but not limiting a cross or the line of its upper side or special points that will be marked on it, as in FIG. 8, to help the process of calibration and tracking of the 2D or the 3D camera when capturing KlikePad's position and movements.

According to some embodiments of the invention, the sensors-hub processes in real-time all inputs from KlikePad and the targeted device's sensors, and uses algorithms to cross-reference the captured data, and derives more meaningful and accurate results on but not limiting user's or KlikePad's position or motion or user's body's parts movements, or translation of user's physical commands into digital commands that activate both KlikePad and targeted device. The cross-reference process can use any other connected available sources such as stored data on both devices, or stored data on cloud, such as but not limiting the pixel model of the user's body's parts or of the KlikePad.

According to some embodiments of the invention, the sensor-hub can be a stand-alone hardware or software that has a script language to define and handle any sensor type and synchronize the streaming of data from any pre-define type of sensors and a set of algorithms and computerized procedures to cross-match the data from different multiple sensors to produce results that are aimed to map and describe user's real world physical parameters such as his 3d position and movements, brain's activities, temperature and more other parameters.

According to some embodiments of the invention, the sensor-hub can send in real-time feedback to the sensors or change sensors configuration according to the streaming sensors data.

According to some embodiments of the invention, for each set of inputs generated by human and machine activities and captured by the sensors and touch screen on the KlikePad, activates appropriate activity in the targeted device application/operating system.

According to some embodiments of the invention, the movement of fingers on part or all the space of the touch screen along both horizontal (x1 millimeters on the x axis) and vertical (y1 millimeters on the y axis) activates movement on the targeted screen in the length of x2 millimeters on the x axis and y2 millimeters on the y axis where x2/x1 and y2/y1 are predefined factors. The movements on the targeted screen can be of the screen's cursor on the targeted device's screen's coordinate system, or along the (x, y) axis of a 3d object that is presented on the targeted device's screen, or can be the movements of the 3d object in the (x, y) directions in a coordinate system presented on the targeted device's screen, or movement of the coordinate system itself.

According to some embodiments of the invention, a movement of fingers along a predefined path that can be on the right side or the left side of the touch screen, in the down or in the up direction along y3 millimeters on the y axis, activates movement on the targeted screen in the length of z3 millimeters where z3/y3 is a predefined factor. The movement can be also horizontal on the bottom or top edges of the touch screen along x3 millimeters on the x axis, and activates movement on the targeted screen in the length of z4 millimeters where z4/x3 is a predefined factor. The movements on the targeted screen can be of the screen's cursor on the targeted device's screen along the z axis of a 3d object that is presented on the targeted device's screen, or can be the movement of the 3d object in the z axis in a coordinate system presented on the targeted device's screen, or movement of the coordinate system itself in its z axis. Optionally this movement on the screen can translated to zoom in or zoom out operation. Moving 2 hand's fingers one on part or almost all the space of the touch screen along both horizontal and vertical axis and a second finger up and down the right or left edge of the screen can activate linear movements on the targeted screen in all three (x, y, z) axis in the same time.

According to some embodiments of the invention, the movement of KlikePad in space by x1 millimeters on the x axis and y1 millimeters on the y axis and z1 millimeters on the z axis, that is captured by the devices sensors such as the motion sensors of KlikePad or the 2D or 3D camera on the targeted device, activates movement on the targeted screen in the length of x2 millimeters on the x axis and y2 millimeters on the y axis and z2 millimeters on the z axis where x2/x1 and y2/y1 and z2/z1 are predefined factors. The movements on the targeted screen can be of the screen's cursor on the targeted device's screen's (x, y) coordinate system, or along the (x, y, z) axis of a 3d object that is presented on the targeted device's screen, or can be the movements of the 3d object in the (x, y, z) directions in a coordinate system presented on the targeted device's screen, or movement of the coordinate system itself.

According to some embodiments of the invention, the rotating movement of KlikePad in space by Rx1 degrees on the x axis and Ry1 degrees on the y axis and Rz1 degrees on the z axis, that is captured by the devices sensors such as the motion sensors of KlikePad or the 2D or 3D camera on the targeted device, activates rotating movement on the targeted screen of Rx2 degrees on the x axis and Ry2 degrees on the y axis and Rz2 degrees on the z axis where Rx2/Rx1 and Ry2/Ry1 and Rz2/Rz1 are predefined factors. The rotating movements on the targeted screen can be of the screen's cursor on the targeted device's screen's (x, y) coordinate system, or along the (x, y, z) axis of a 3d object that is presented on the targeted device's screen, or can be the rotating movements of the 3d object in the (x, y, z) directions in a coordinate system presented on the targeted device's screen, or rotating movement of the coordinate system itself (FIG. 8).

According to some embodiments of the invention, the rotation movement of the KlikePad can be combined in the same time with linear movement on touch screen as in [0017] or linear movement of the KlikePad in space as in [0018] to generate a combined movement on the target device screen in all 6-degrees of freedom.

According to some embodiments of the invention, x2/x1 and y2/y1 and z3/y3 and Rx2/Rx1 and Ry2/Ry1 and Rz3/Ry3 factors can be dynamically dependent on the speed or/and acceleration of the movement of the fingers on the touch screen or the KlikePad movement in space. For example, the faster the movement is done, the distance of the movement on the targeted device will be longer, or the rotation will be of more degrees.

According to some embodiments of the invention, all movements that are done on the touch screen of the KlikePad or by moving the KlikePad in space can activate movements on a small window on the targeted device's screen that is the zoom of small portion of the original object on the screen, in factors of Px in the x axis and Py in the y axis where each 1 centimeter that the user moves the cursor in x or y axis in the zoom window is translated into 1/Px or 1/Py centimeter in the original window and by that let the user work with higher resolution when he makes his moves. Those user's movements can in the same time affect and be shown on the zoomed portion of the object in the small window, and on the original object itself.

According to some embodiments of the invention, the remote control device such as smartphone with the 3d controlling functions, such as but not limiting the KlikePad, can be used as a console to operate a 3d software to build and process 3d objects.

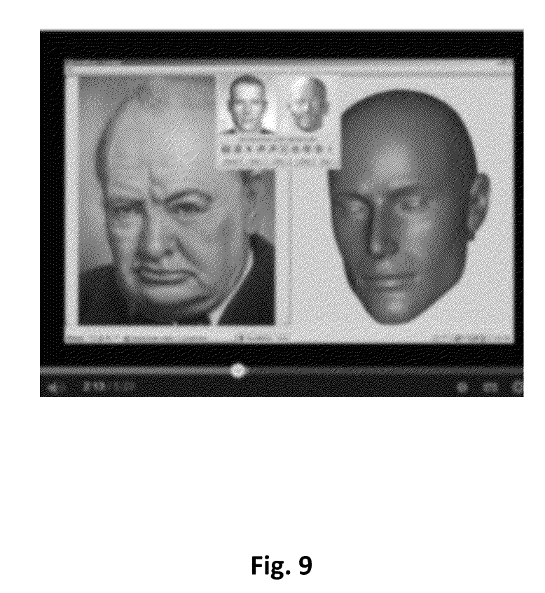

According to some embodiments of the invention, the remote control device such as smartphone with the 3d controlling functions, such as but not limiting the KlikePad, can be used as a console to operate a 3d software game. Such game but not limiting can present the user two objects that one of them has a pixel model in 2D or 3D, and the second one with no pixel model. In this game the system automatically put a point or draws a curve on the object with the pixel model and the user follows this point or curve by using the smartphone touch screen or using the KlikePad as a console and allocating manually a similar point or draw a similar curve on the second object by user's manual best efforts to match the points and curves on the pixel model of the first object. A geometric algorithm computes the matched points and curves on both objects and derives out of them the pixel model of the second object. For example but not limiting, if two faces are given and the system put a point on the nose of the first face object, then the gamer should put a point on the nose of the second object. The system then by algorithmic 2D or 3D computation, can build a 2D or 3D pixel model for the second object. The gamer is measured by the accuracy of the points and curves allocation and for succeeding to do so in response to variable, accelerating or random speed of the system drawing points and curves. The process can be repeated to cover more angles and orientations of the second object and to end with a full 3d model (FIG. 9).

The new pixel model of the second object can then be rotated and manipulated in various ways for example in the face example, such as but not limiting to extend the length of the nose in a funny way. The process can be done by crowd effort to build a big 3d pixel models for objects, famous people, buildings and more.

According to some embodiments of the invention, part of the digital information attached to a given object with a known partial of full identification, can be reached when identifying the object, and can be related to its ‘physical and virtual properties’ in various positions and various time and place instances such as but not limiting its 2D and/or its 3D properties, represented by but not limiting its 2D and 3D pixel model and other physical properties such as its temperature, colors, and more, that relate the object. For example but not limiting the 2D or 3D pixel model of personal human body's parts, his personal stuff such as his personal phone and more.

According to some embodiments of the invention, any capturing or sensing system such as but not limiting 2D or 3D camera connected to a processing unit that can identify the existing of the object in a bigger scene, or the position of this object, can use the attached object's data of its physical and virtual properties, to process or manipulate various activities. Such attached data, for example for objects such as but not limiting personal body's parts, can be but not limiting the pixel model of the fingers when making the KlikeGest gesture and a gripping gesture in many positions and angles in front of the camera, or nodding with the head, waving hands and more. The pixel model data of such gestures can be used for calibration, or recognition or training of those gestures by the system with the 2D or 3D camera.

According to some embodiments of the invention, capturing and storing in a reachable database the data of the object's physical and virtual properties of each object can be done by the object's manufacturer or/and supplier, or captured manually by object's owner by using several means such as but not limiting 2D or 3D camera.

According to some embodiments of the invention, object's physical and virtual properties of each object can be stored in owner's digital devices or in private or public servers or in the cloud, and be retrieved by communication means such as but not limiting via Bluetooth, camera that reads barcode, or RF or NFC readers that refer the user to the address where he can locate the full information of the given object.

According to some embodiments of the invention, the usages of information of object's physical and virtual properties can be but not limiting for example in recognition of gestures done in front of 2D or 3D camera by moving objects such as body's part especially hands, head and fingers in various position, or of capturing the movements of devices such as but not limiting the KlikePad which can be user's own smartphone. For example, knowing beforehand the pixel model of the user's fingers or the moving smartphone can add to the accuracy of capturing and processing the gestures information done by the user.

According to some embodiments of the invention, the usages of this information of object's physical and virtual properties can be but not limiting help robots navigate and act in a familiar surrounding or in a new place. The robot reads or recognizes the object's identification, then retrieves its attached data and uses it for example but not limiting to decide its orientation or its next move.

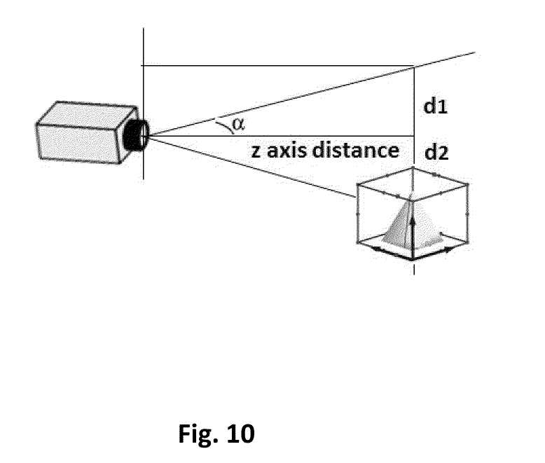

According to some embodiments of the invention, a known object's pixel model can be used by the 2D or 3D camera for getting the right perspectives of a nearby other object and from this, to process and measure the other object's parameters. For example if the camera refers to a physical object that generate a line with known angle to the camera axis coordinate, the distant of any other object in the z axis can be measured by triangulation with its (x, y) projection on this line as is measured by the 2D or 3D camera and the known angle of the line. The line can be a physical one or being generated by a beam of light that is measured by the 2D or 3D camera (FIG. 10).

According to some embodiments of the invention, in the process of developing and/or the process of testing the algorithms of recognition of gestures done by free hand, and/or by fingers, and/or by head or by other part of the body, and/or by object that is held by the hand while moving it in the air, and in the process of developing and testing the impact of those gestures on the targeted device application and applications' objects, the gestures as captured by 2D or 3D camera can be visualized in the targeted device's screen in a transparent image that covers the visualization of the application and its objects, and show both gestures and application's image in the same time one over another.

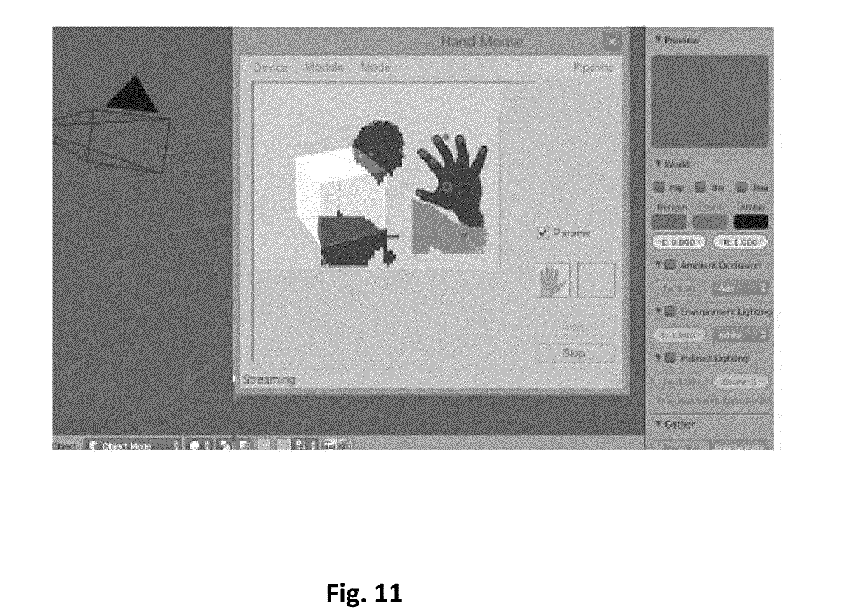

One application can be a grid with numbers, and using it together with the transparent image of the gestures can give the exact position of the moving hand or fingers or head or other part of the body or the object in hand, and by that the developer can test the accuracy of the gesture capturing by the 2D or 3D camera (FIG. 11).

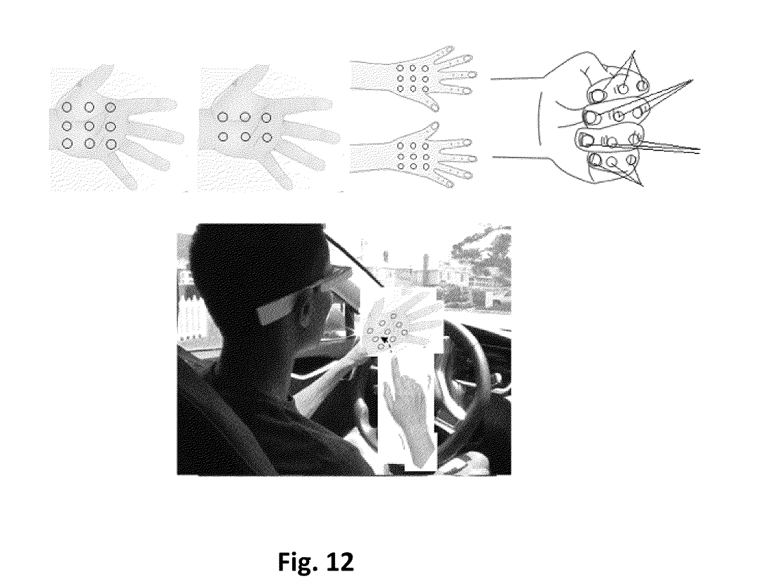

According to some embodiments of the invention, any surface such as but not limiting a touch screen, or a ‘virtual pad’ which is a non-active object such as the palm of the hand or other part of the hand or any other object that can have distinguishable parts or points which their location can be captured and identified by sensors such as but not limiting 2D or 3D camera, that can be embedded or attached to for example but not limiting glasses or wearable device, keystroking on them with the fingers can be done with various ‘Keystrokes types’ such as but not limiting a short and long touch, multi-touch, gesture touch that starts from the touched point as a center point and directed out of this point to other direction, tapping with different fingers and more. The system activates according to the touched point and the type of the keystroke, commands and activities on any of or all the connected devices such as the KlikePad or any other smartphone with the touch screen, or on tablets, or on glasses with camera, or on the targeted device, and the commands or activities can be, but not limiting, “Enter” command, simulation of left and right mouse button's, keys of a virtual keyboard such as letters or/and digits, and more (FIG. 12).

According to some embodiments of the invention, the system can let the user keystroke his KlikePad touch screen or his virtual pad with or without looking on it by showing the user on the targeted device's screen a virtual keyboard that its content is context-dependent of the current active application or system status, where each square refers to a specific square or point or location as of the virtual keyboard on the KlilePad's touch screen or the virtual pad, and keystroking with the finger using any of the keystroking types on one square on the KlikePad's touch screen or the virtual pad, activates command or/and activity on the KlikePad or on the targeted device as is shown on the square that is located on the similar relative position on the targeted virtual keyboard on the targeted device. The layout can be but not limiting a 3×3 squares to activate a full 26 letters English Keyboard or digits or any other language, or 3×4 squares to add to the language alphabet letters, commands such as ‘Enter’, ‘Backspace’ and others. The system can give an audio feedback that confirm the activation of the related activity. The system can activate commands on the targeted device which have the same prefix of letters that are outputted by keystroking on the KlikePad virtual keyboard. The system can train or offer a training program to practice the commanding of the 3×4 letters layout on the KlikePad or the virtual pad device by practicing a blind typing on it while looking on the screen and by that train and remember the position of the squares or the points so that the fingers reach without looking the exact place of the square or point, and then train and remember the position of each letter or symbol on the 3×4 matrix.

According to some embodiments of the invention, all the activities on the KlikePad's touch screen, can be replaced by a similar device to KlikePad, that instead of the touch screen it has a trackball that can move the cursor on the device screen, or any other kind of pad, and can be pressed in short or longer time press to mimic short and long keystroking on the KlikePad touch screen.

According to some embodiments of the invention, the remote controlling device such as KlikePad can use additional accessories, such as but not limiting magnets, to empower the controlling tasks or to improve the accuracy or to amplify the results of the gyroscope, or/and compass, or affect their 3D orientation, or accessories that are sensitive to pressure to affect the behavior of the accelerometer, or accessories to affect the accuracy of the 2D or 3D camera.

According to some embodiments of the invention, the accessories added to the remote control device can be magnets that are put in positions to change or amplify the results in the motion sensors.

According to some embodiments of the invention, the accessories added to the remote control device can be sensitive to pressure, for example but not limiting to affect the behavior of the accelerometer.

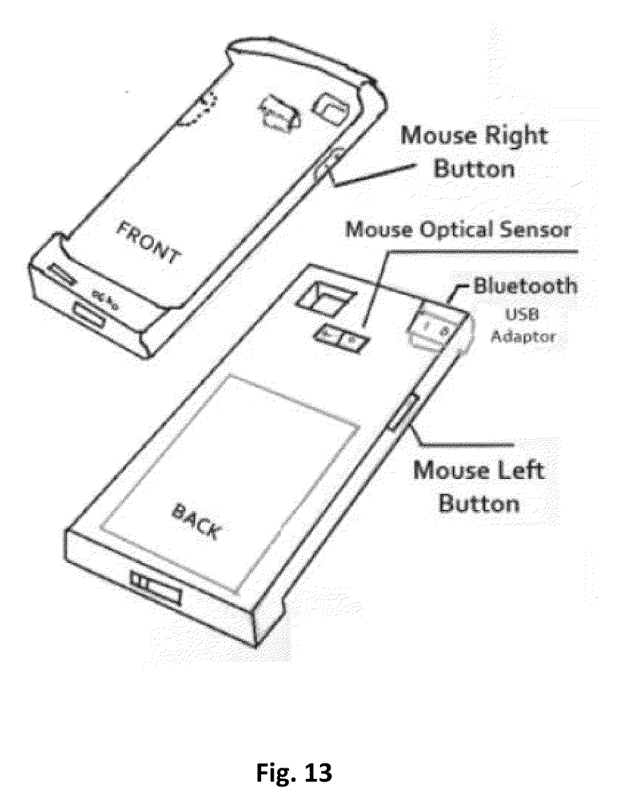

According to some embodiments of the invention, the remote controlling device that simulates a physical mouse, can be a battery accessory such as Powerbank, which acts as an extra battery and a shield that is usually attached permanently to the smartphone, integrated with physical mouse hardware components, such as the navigation control, which can be a hard rubber track ball or an optical laser, the connectivity component, which can be wireless such as but not limiting Bluetooth, the left and right buttons, and the scroll wheel. The components are integrated with the Powerbank and use its battery for electric power. The integrated device of Powerbank and mouse components can be used in the same way that a physical mouse is being used, controlling and moving the targeted device's cursor, or clicking on the mouse buttons. It can works as a standalone accessory or attached to the smartphone as a shield, in this case the two devices are moving together in the same time in the same directions (FIG. 13).

According to some embodiments of the invention, the physical interface device which simulate mouse interface capabilities can be incorporated with a Powerbank device and the smartphone can work separately or have their input synchronized together when processed by the targeted device in dependence of the 3 devices status and activities. For example, the smartphone shielded by the Powerbank can be used as one unit similar to a physical mouse, and the smartphone touch screen can be used as additional way for moving the cursor on the targeted screen or/and for keystroking on a virtual keyboard that send its keystrokes to the targeted device, for example but not limiting move the cursor on the z axis on a 3D object on the screen, or move the 3D object in the z axis, or move the coordinate system of the 3D scene in the z-axis, or rotate a line or a 2D or a 3D objects in any chosen axis.

According to some embodiments of the invention, the Powerbank that shields the remote control device can embed a trackball or a pad that can control the remote control device such as smartphone or/and can control the targeted device.

According to some embodiments of the invention, the Powerbank that shields the remote control device can embed a physical or virtual keyboard with small touch screen pad in any layout especially with the 3×3 letters layout.

According to some embodiments of the invention, a reduced keyboard layout consists of number of adjacent areas, one of them is the one that represents the ‘blank’ key, and each one of the others can contain and present one or more letters or/and symbols, that can be keystroked by various keystroke types 0 such as but not limiting the ‘amyjon keyboard’ with 2×3 areas on each area there are 2 sets of letters,

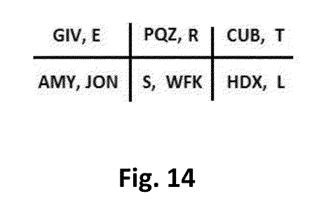

A11={(‘g’, ‘i’, ‘v’), ‘e’}, A12={(‘p’, ‘q’, ‘z’), ‘r’}, A13={(‘c’, ‘u’, ‘b’), ‘t’}, in the first row and A21={(‘a’, ‘m’, ‘y’), (‘j’, ‘o’, ‘n’)}, A22={(‘s), {(‘w’, ‘f’, ‘k’)}, A23={(‘h’, ‘d’, ‘x’), ‘l’}, in the second row, and the first set on each area {(‘g’, ‘i’, ‘v’), (‘p’, ‘q’, ‘z’), (‘c’, ‘u’, ‘b’), (‘a’, ‘m’, ‘y’), (‘s), (‘h’, ‘d’, ‘x’)}, is chosen when there is a keystroke on this area by a long keystroke, and the second set on each area {(‘e’), (‘r’), (‘t’), (‘j’, ‘o’, ‘n’), (‘w’, ‘f’, ‘k’)}, (‘l’)}, is chosen when there is a keystroke on this area by a short keystroke, the decision when given a sequence of keystrokes from various keystroke types on various areas, which is the one sequence of letters or/and symbols that the user has intended to write is done in two steps,
the first checks automatically if there is a unique sequence of letters that is a full word or a prefix of a word which are ‘legal word or prefix’ in the given language, in all the ‘possible sequences’ which are the combinations of sequences of letters that can be generated by allocating for each keystroke in the sequence, which is being keystroked on a specific area and specific keystroke type, one letter that belongs to the set of letters on this area that are attached to the specific keystroke type, in this case this is the chosen letters sequence,
otherwise, i.e. there are more than one sequence which are legal words or prefixes, if the last keystroke is not blank then the system cannot decide, and is waiting for the next keystroke, otherwise the user has written the full word and the system should offer all the possible sequences of legal words from the possible sequences, and by manual intervention the user will choose the one he has intended to write (FIG. 14).

### Flow Diagram:

a) The algorithm checks if current sequence of {(A1, A2, . . . . A(i−1)) keystrokes, each of type TYPEi and on AREAi where (AREAi×TYPEi) represents a group SETi of letters}
   that its possible sequences that are generated by choosing consecutively one letter from each SET, have one sequence of legal word or prefix.
   If yes—this is the chosen word or prefix
   If not—and there more than one sequence with legal word or prefix, the system waits for the next stroke.
   If there no legal word or prefix, the system gives an indication that the word is misspelled.
   For example—for the following sequence of sets—GIV, GIV, R (i.e. keying twice with short keystroke on the first upper square, then a long keystroke on the second upper square) The possible sequences are:
   GGR or GIR or GVR or IGR or IIR or IVR or VGR or VIR or VVR from which only GIR and VIR are legal prefixes. Because there are more than one sequence with legal prefix, the system cannot decide what to choose and has to wait for ‘L’ (for GIRL) or ‘A’ (for GIRA or VIRA).
b) The user makes the next keystroke.
   If it is blank then show the user all possible sequences for his manual choice one of those possibilities.
   Otherwise go to (a) to check again for unique legal word or prefix.
   In the example—if the next keystroke is a long keystroke on the third area of the bottom row, (i.e. not blank—the algorithm go back to (a) and can decide on GIRL.
   If the next keystroke has been instead a short keystroke on the first area of the bottom line (AMY), the flow goes back to (a) to decide again that it cannot decided on the basis of current sequence because the possible new sequences that are legal are GIRA (maybe will end as Giraffe) or VIRA (for Viral), again more than one legal prefixes, and the system goes to (b).

Any legal word in English can be checked out in this process, and it assumed that for this AmyJon keyboard for English, the number of undecidable words that need manual intervention in choosing the right word by the user are relatively few.

According to some embodiments of the invention, the group of sequences that represent legal words and are given for the user to choose can be ordered according to language considerations such as but not limiting the words frequencies and the context of the sentence and subject of the text in which the word is located.

According to some embodiments of the invention, a reduced virtual keyboard is “practical keyboard” if the process based choosing the right prefix or word after keystroking on squares that have more than one letter, is done in almost all cases automatically as most of the time there is only one unique sequence which is a legal word or prefix, so that the result are on unambiguous, and the manual intervention of choosing from a list of possible words is minor and represents very few percentages in the language's dictionary or in the language's dictionary without very rare used words, or in a dictionary of words of a specific domain such as but not limiting medical words.

According to some embodiments of the invention, the method to build a practical reduced virtual keyboard for a given language is to combine together in each list of letters (L1, L2, . . . . , Ln) that are activated by the same keystroke type and are on the same area, those that have very small number of different legal words that contain one or more of them, for example letter Li, and that replacing this letter in its same place in the word with other letter Lj from the list yields to another legal word.

According to some embodiments of the invention, reduced virtual keyboard in which one keystroke with the same keystroke type hits several letters that are presented on the same area, and a selection method decides which is the one letter that the user has intended to write by deciding if a legal word has been generated, can be targeted to specific lexicons of special domains such as but not limiting technical words in the medical domain, or subsets of this and other domains, and this is done by using a trade-off policy on a set of measures such as but not limiting the minimum number of areas, the minimum number of manual interventions when the automatic process cannot decide which sequence of letters to choose, the easiest combination of letters in each area for the user to remember, and more.

According to some embodiments of the invention, text inputting in any language when the input signals that can call for action come from a limited set of signals, such as but not limiting 2 when signaling for example by closing the eye, or 3 or less than 10, then the texting system will offer dynamically choices of letters or/and words prefixes or/and words or/and sentences. For example in the case of 2 input signals, as of the signal that can be generated and transmitted by the brain, for inputting the next keystroke, the system show dynamically one after another each couple of (area, keystroke type), and the user confirms, and in this case the system starts in the process of inputting the next keystroke, or the user does not response, and the system shows the user the next couple of (area, keystroke type), and try to react according to his response. The flow of choices can be arranged by a decision tree of letters groups with dynamic order that depends on predication methods of the next letter in the word.

According to some embodiments of the invention, all the letters can be divided to sets of groups, with one or more letters in each group according to a layout of a given reduced keyboard, and the system shows each group in a fixed order or in a flexible order for example but not limiting showing a set with many vowel letters after showing a set with many syllables, to let the user confirm or not if the letter is in the current set or not, and those sets can be but not limiting AmyJon with its 12 different groups of letters that each groups' letters are being hit together, and in this case the user can reach the right choice of the next letter by no more than 4 steps:

The system shows {(Amy, e), (giv, jon)} and user makes his first decision D1 to confirm if the letter is in string ‘amyegivjon’.
If yes, the systems shows {amy, e} and the user confirms if letter is in string ‘amye’, if no, the systems understands that it is in string ‘givjon’, so if it has been yes the system shows ‘amy’ and the user makes his final decision to confirms that the letter is there or else the letter is understood to be ‘e’,
otherwise the system shows the ‘giv’ and the user makes his final decision to confirm that the letter is there or else the letter is understood to be in ‘jon’ (to be manipulates later with the Amyjon algorithm).
Otherwise, if first decision D1 implies that letter is in [(zpq, r), (s, t)], [(cub, wfk), (dhx, l)]}, the systems shows [(zpq, r), (s, t)] and the user makes decision D2 to confirm if letter is in string ‘zpqrst’, if no, the systems understands that it is in string [(cub, wfk), (dhx, l)], so if it has been yes the system shows (zpq, r), and the user makes his decision to confirm (if yes the system will show ‘zpq’ and the user makes his final decision if the letter is there or else it is ‘r’, if no, the system shows ‘s’ and user makes his final decision and choose it or else it is understood that the letter is ‘t’)
Otherwise in decision D2 if the user does not confirm, the system shows the (cub, wfk) and the user makes his decision to confirm that the letter is in ‘cubwfk’ (and then the system shows ‘cub’ and the user can confirm or else it is understood that the letter is in ‘wfk’) otherwise the letter is understood to be in ‘dhxl’ and the user is shown ‘dhx’ that he can choose it or else it is understood that he wants letter ‘l’ (and when having the 3 letters string it is manipulates later with the Amyjon algorithm).

According to some embodiments of the invention, in any digital device with touch screen, clicking on some points on the touch screen that are on the edge of it or clicking on some points that are very near the edge of the touch screen but are not on the touch screen itself, or clicking with one touch of the finger on points that are on both sides of the edge, can activate special activities on the digital device, for example but not limiting activate control buttons, or but not limiting getting the effect of keystroking on various letters from the language alphabet such as but not limiting the less frequent letters such as ‘z’ or T or ‘k’ in the English alphabet. The keystroke can be done in a way to distinguish from regular keystroking such as hitting twice the point or keystroking in a pre-defined sequence various points on the edge or on the touch screen itself.

According to some embodiments of the invention, a trackball or a small pad attached or embedded in a digital device such as but not limiting a smartphone, tablet, a Smartwatch and digital glasses, can control a cursor on a screen that shows a layout of squares or icons that represents a reduced virtual keyboard. The reduced virtual keyboard can be based on algorithm and layout as of but not limiting with any of its layouts and languages. On each square there will be one or more letters of the language alphabet or symbols that activate actions, and the trackball or pad can have any of the keystrokes types such as but not limiting a short keystroke or a long one, that activates a specific letters/actions out of a given square of the reduced virtual keyboard layout.

According to some embodiments of the invention, an easy texting by a trackball or a small pad or a touch screen, simulating keystroking on reduced virtual keyboard such as but not limiting the keyboards, that are attached to or embedded in a digital device such as but not limiting a Smartwatch, or glass enables activities such as but not limiting reminders to the user such as but not limiting actions items, meetings, TV programs, new coming e-mails or SMS or voice call in silent mode, smartphone status such as battery consumption, notification on radiation; snapshots of ideas, photos, videos, voice recording, URLs; SMS interaction; Proxy activities to notify nearby friend, smartphone and PC locker; transferring one's details such as visiting to others; full to-do list; personal time monitoring; fitness sensors measurement; one-liner or short text jokes; fast e-learning procedure such as but not limiting learning of new word in foreign language; motion sensors measurement to find and measure spatial position; 2D or 3D camera and related activities such as gestures capturing and recognition; smart coupons applications; inputting activities such as but not limiting SMS and instant messaging texting, tagging or/and writing titles for snapshots and clicking on control buttons; projecting content on external screens; remote control of PC and other digital devices; containing passwords for using other devices and other devices' applications; emergency button for anti-attack purposes or SOS for elderly people or for people with disabilities; compass for navigation; location and/or time logging (done by user intentionally); marking items by camera scanning; and QR reader;

According to some embodiments of the invention, in any digital device that has a screen, such as but not limiting a smartphone or a smartwatch, any content can be displayed in the minimal font size that this device can apply, and be zoomed by physical magnifier, and the font is build such that as when being magnified, the font's pixels scale to let human eyes extrapolate the pixels and get the feeling of reading a clear letter. Special care in building each font will be for distinguishing the letter from other letters that are similar to it and can confuse the reader. For example but not limiting ‘Q’ and ‘O’, ‘a’ and ‘o’, ‘c’ and ‘e’. The problem in magnifying fonts that are usually with the minimal number of pixels, is losing the focus of this font and making it fuzzy in a way that can be confused with fonts that are similar to each other or for fonts that this can make them too close together and stick to each other. One of the solutions to solve this problem is to combine many sets of different fonts and dynamically choose those that cannot be confused with others when magnified, or those that are not sticking with their neighbors letters in a given word.

A new set of fonts aimed for this purposes can be generated and built.
(Referenced to patent application 2007/0216687 Kaasila e al. Sep. 20, 2007—Methods, systems, and programming for producing and drawing subpixel-optimized bitmap images of shapes, such as fonts, by using non-linear color balancing).

According to some embodiments of the invention, in any digital device that has a screen, such as but not limiting a smartphone or a Smartwatch, the content can be displayed in a way that enables fast reading and fast attention grabbing, for example but not limiting scale the font size or change font type of some or all of the letters of the word such as the two first letters and the last letters of one word and similar changes in other word. The content can be shown in dynamic way that speed the reading without damaging user's understanding or quality of reading.

Automatic text and scene understanding methods can be applied to emphasize dynamically the streaming content speed and font size and font type according to general known measures or know abilities of the specific user in a way that optimize her/his reading process.

According to some embodiments of the invention, a central processing and storage unit with communication abilities can act as a sensor-hub or be added to a sensor-hub and manage messages in real-time in a meeting of two or more participants that have smart-glasses such as but not limiting Google-glass, it can access in real-time a central data-base and based on its data and the participants' messages it can send in real-time pre-prepared information or new information based on participants' feedback in voice, texting or gesturing.

According to some embodiments of the invention, smart-glasses such as but not limiting Google-glass, can show on its front or its side parts or attached to its rear part pictures or/and text that can be targeted but not limiting to advertisement or other data, and can be displayed on a screen with dynamic change of the data that is shown on it.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, materials or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMS. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

What is claimed is:

1. A method of activation functions of application in a target computer device including 3d movements functions, using a smart mobile device, said method comprising the steps of:
receive inputs from the smart mobile device sensors including at least one of: motion sensor: tilting/accelerator sensor to identify motion or orientation of the device in space and identify touch screen inputs that follow the fingers movement on the touch screen or the hovering of the fingers over and/or keystrokes;
receive inputs from camera and/or microphone of the target computer device capturing movement and orientation of smart mobile device as moved by the user's hands and or motion of user's body parts;
applying script language and algorithms enabling to translate and synchronize data from various sensors of the smart mobile device, by applying cross-match algorithm on data from different multiple sensors to map and describe user's real world physical motion and orientation parameters such as his 3d position and movements;
processing simultaneous inputs data from the smart mobile device including data of motion of fingers along the touch screen or/and identified motion, a linear movement and/or a rotation movement of the smart mobile device by the user's hands, and/or the data from camera of the target device which identifies the movements of the smart device to determine user 3D control commands based on pre-defined rules, using parameters which relates to at least one of: fingers motion along the touch screen movement in space, tiling movements of body's parts or hands grabbing and/or moving the smart phone device in space; and
translating determined control commands into instructions of designated application of the target computer device or the mobile device.

2. The method of claim 1 further comprising the step of: Translating control commands into objects or coordinate system movements on the screen of target computerized device.

3. The method of claim 1 further comprising the step of sending in real-time feedback to the smart device to activate processes thereof or to the sensors to change sensors configuration based on analyzed sensor data.

4. The method of claim 1 wherein the commands include building 3D objects models by a user based on equivalent 3D objects presented to the user on the target screen.

5. The method of claim 1 wherein the commands include operating 3D game on the target computerized device.

6. The method of claim 1 wherein using given 3D pixel objects models of user's organs to identify finger touch in pre-defined locations on the user organ or an object enabling to simulate reduced keyboard for using with smart mobile device, where each predefined location on the organ or object simulate at least one key or function in the smart mobile device.

7. The method of claim 1 wherein the identifying user finger movement along predefined path along the screen, is translated into predefined graphical command including movement of an object in a third dimension or zooming in or out.

8. The method of claim 1 wherein identifying the movement of a first finger of user's hand along horizontal and vertical axis along the smart device touch screen and a second hand's finger along a predefined path can activate linear movements on the targeted screen in all three (x, y, z) axis in the same time.

9. The method of claim 1 wherein 7 wherein each movement of the finger on the screen is translated into different proportion of movement on the target screen based on pre-defined factor.

10. The method of claim 1 wherein 8, wherein each movement of the finger on the screen is translated into different proportion of movement on the target screen based on pre-defined factor.

11. The method of claim 1 wherein 7 wherein the predefined path is along the edge of the smart device touch screen.

12. The method of claim 1 wherein 8 wherein the predefined path is along the edge of the smart device touch screen.

13. The method of claim 1 wherein the process simultaneous inputs data include integrating data information of 3D movement of the smart phone with finger movement of the smart phone screen for determining specific control commands.

14. A method of activation functions of application in a target computer device including 2d and/or 3d movements functions, using a smart mobile device associated attached with interface device simulating electronic mouse interface capabilities, said method comprising the steps of:
receive inputs from the smart mobile device sensors including at least one of: motion sensor: tilting/accelerator sensor to identify motion and orientation of the device in space and identify touch screen inputs and/or keystrokes;
receive inputs from the interface device;
applying script language and algorithms enabling to translate and synchronize data from various sensors of the smart mobile device and input data of the interface device, by applying cross-match algorithm on data from different multiple sensors to map and describe user's real world physical motion and orientation parameters such as his 3d position and movements;
process simultaneous or one after another, inputs data from of the smart mobile device and the interface device to determine user 2D or 3D control commands based on motion of fingers along the touch screen movement in space or tiling movements of body's parts or hands grabbing and moving the device in 2D or 3D in space; and
translating determined control commands into instructions of designated application of the target computer device.

15. The method of claim 14 wherein the smart mobile device includes reduced keyboard layout which consists of number of adjacent areas, one of them represents a ‘blank’ key and each one of the others areas contains and presents one or more letters or/and symbols, that can be keystroked by various keystroke types.

16. A method of activation functions of application in a target computer device including 3d movements functions, using a smart mobile device associated with interface device simulating electronic mouse interface capabilities, said method comprising the steps of:
receive inputs from the smart mobile device sensors including at least one of: motion sensor: tilting/accelerator sensor to identify motion and orientation of the device in space and identify touch screen inputs and/or keystrokes;
receive inputs from the interface device;
receive inputs from camera and/or microphone of the target computer device capturing movement and orientation of smart phone/pad device and or user body parts;
applying script language and algorithms enabling to translate and synchronize data from various sensors of the smart mobile device and input data of the interface device, by applying cross-match algorithm on data from different multiple sensors to map and describe user's real world physical motion and orientation parameters such as his 3d position and movements;
process simultaneous inputs data from of the smart mobile device, the interface device and camera of the target device to determine user 3D control commands based on motion of fingers along the touch screen movement in space or tiling movements of body's parts or hands grabbing and moving the device in space; and
translating determined control commands into instructions of designated application of the target computer device.
